(19) United States
(12) Patent Application Publication
(10) Pub. No.: US 2007/0013668 A1
(43) Pub. Date: Jan. 18, 2007

(54) Recessed touch pad

(75) Inventors: Kai-Chen Tien, Taipei City (TW); Wei-Huan Chou, Taipei City (TW); Hui-Chen Wang, Taipei City (TW); Chi-Fen Chang, Taipei City (TW); Ming-Hui Chen, Taipei City (TW); Shu-Hua Lai, Taipei City (TW)

Correspondence Address: REED SMITH LLP, Suite 1400, 3110 Fairview Park Drive, Falls Church, VA, 22042, US

(73) Assignee: Inventec Corporation

(21) Appl. No.: 11/181,784

(22) Filed: Jul. 15, 2005

(51) Int. Cl. G09G 5/00

(52) U.S. Cl. 345/173

(57) ABSTRACT

A recessed touch pad comprises a case, a touchpad module, an extension and retraction mechanism and a data transmission interface. The case, equipped with a motherboard of notebook, has a storing space and a storing port. The touchpad module is used to control the shift of display cursor of notebook, while the extension and retraction mechanism is placed between the case's storing space and touchpad module, such that the touchpad module can exit/enter the storing space via the storing port. Besides, a data transmission interface is placed between the case and touchpad module to transmit the signal of touchpad module. Based on this recessed touch pad, notebook's keyboard is located backwards and the drop height of operating panel and tabletop is minimized in favor of the ergonomics for long-lasting operation.

### BACKGROUND OF THE INVENTION

1. Field of the Invention

The present invention relates generally to a recessed touch pad, and more particularly to a recessed touch pad which is well-suited for notebooks with modified frontal thickness and keyboard position in favor of ergonomics.

2. Description of Related Art

With the rapid development of computer industry and state-of-the-art semi-conductor manufacturing technology in recent years, notebook has achieved the same performance as desktop. And, the users have gradually turned to notebook because of its advantage of thin-profile.

As shown in FIG. 1, notebook P1 is currently designed with such interfaces as keyboard P20 and touch pad P30 other than LCD. Given the fact that notebook P1 has a case P10 of a certain thickness, and keyboard P20 is located over it, the operating panel has a drop height to the table. Besides, a touch pad P30 is located at frontal section of the case P10, it is impossible to design a thinner frontal section of case P10. And, keyboard P20 is positioned backwards, it is easy to make your wrists and shoulders stiffer and aching from the point of ergonomics. Therefore, there is an urgent demand to design a notebook that its frontal section becomes thinner, and the keyboard is further located to the frontal section to remove the drop height between the keyboard and table top in favor of the users from the perspective of ergonomics.

### SUMMARY OF THE INVENTION

The purpose of the present invention is to provide a recessed touch pad that the keyboard of notebook is located forwards to meet the design requirements in favor of ergonomics. The present invention comprises: a case of notebook fitted with a storing space and a storing port; a touchpad module including a touch pad and a touchpad model having at least one operating key, which is used to control the shift of display cursor of notebook; a extension and retraction mechanism located between case's storing space and touchpad module, which enables the touchpad module to exit/enter storing space via the storing port, and places the touchpad module into frontal storing space during recovery, or pulls out during operation; and a data transmission interface between the case and touchpad module, which is used to transmit the signal of touchpad module.

### BRIEF DESCRIPTION OF THE DRAWINGS

FIG. 1 shows a perspective view of the touchpad of the conventional notebook computer;

FIG. 2A shows a perspective view of the preferred embodiment of the present invention;

FIG. 2B shows a perspective view of the pulled touchpad module in FIG. 2A;

FIG. 3A shows a lateral view of the touchpad module of the preferred embodiment of the present invention, in closed state; and

FIG. 3B shows a lateral view of the touchpad module of the preferred embodiment of the present invention, in pull-out state.

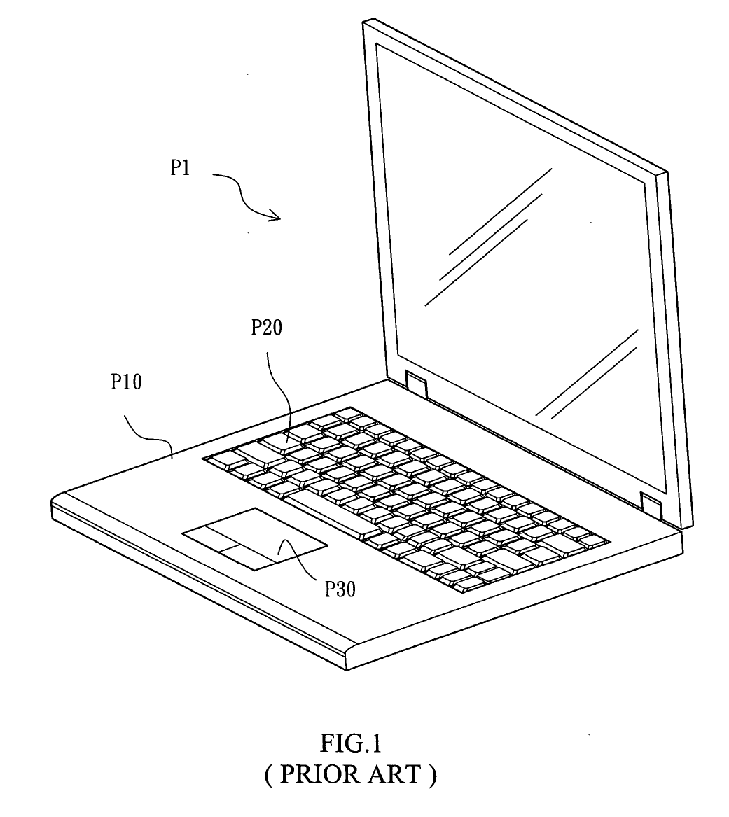

### DETAILED DESCRIPTION OF THE PREFERRED EMBODIMENT

The features and the advantages of the present invention will be more readily understood upon a thoughtful deliberation of the following detailed description of a preferred embodiment of the present invention with reference to the accompanying drawings.

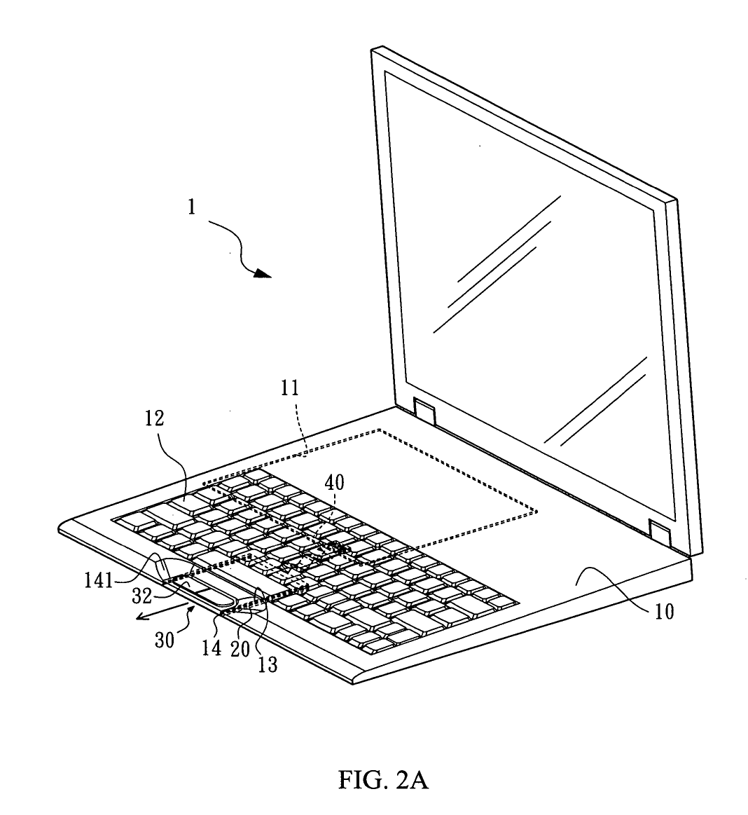

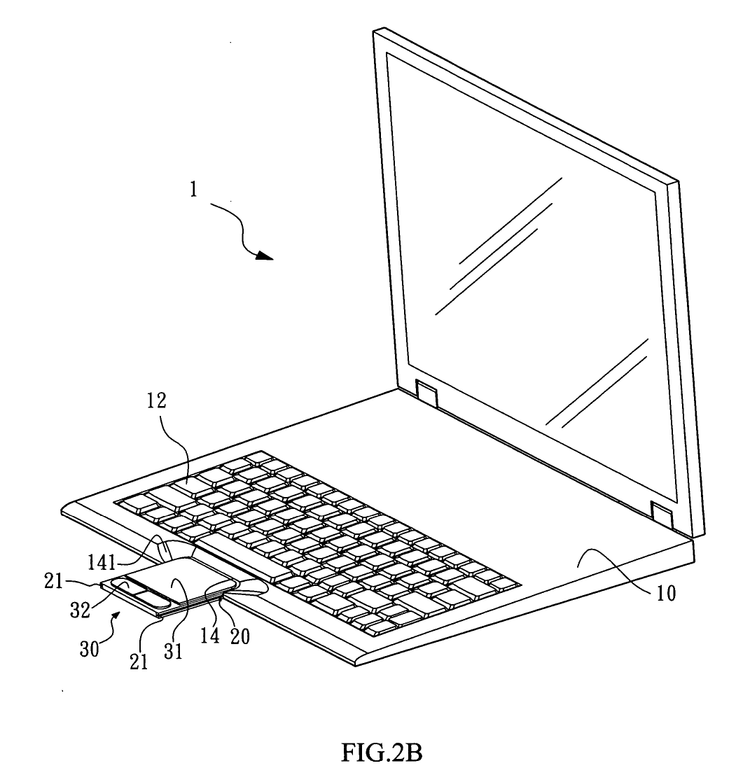

FIG. 2A shows a perspective view of the preferred embodiment of the present invention, which comprises a case 10 of a notebook 1, which is equipped with a motherboard 11, and a keyboard 12, which is located at the upper part of the case 10. Besides, the case 10 is fitted with a storing space 13 and a storing port 14, where a notch 141 is placed over the storing port 14.

A touchpad module 30, which is used to control the shift of display cursor of notebook 1 depending on the touch path. The touchpad module 30 comprises a touch pad 31 and one or more operating key 32 nearby.

An extension and retraction mechanism 20, which is placed between the case 10's storing space 13 and touchpad module 30, and used to enable the touchpad module 30 to exit/enter the storing space 13 via storing port 12, is provided.

A data transmission interface 40, which is placed between the case 10 and the touchpad module 30, and used to transmit the output signal of touchpad module 30, is also provided.

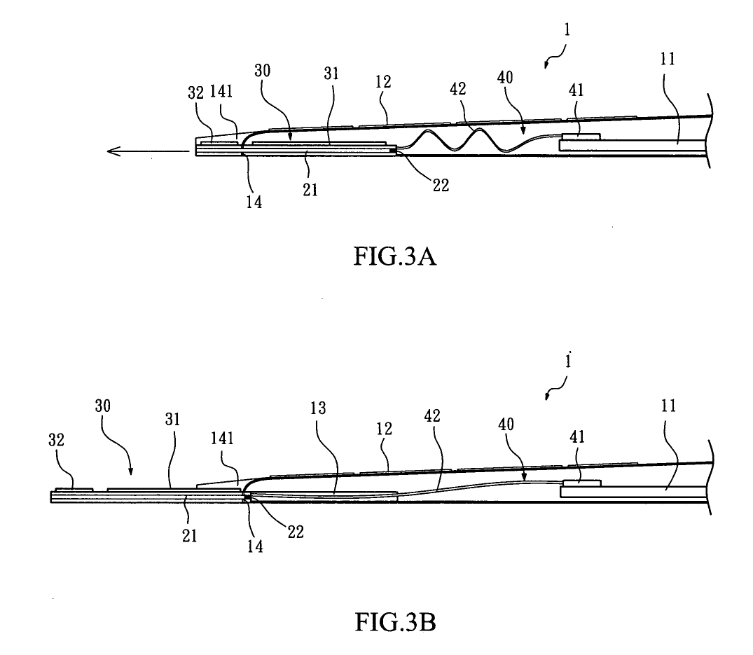

FIG. 2B shows a perspective view of pulled touchpad module of FIG. 2A. The touchpad module 30 is removed from the case 10 of the embodiment, so the keyboard 12 at rear section of the case 10 can be shifted forwards in favor of ergonomics. To accommodate and conceal the touchpad module 30 (the operating key 32 of the touchpad module 30 is exposed as the case 10's storing port 14 is fitted with a notch 141), a storing port 14 is located at side elevation of frontal section of the case 10, and linked to a storing space 13. A extension and retraction mechanism 20, such as a backstop guide trail 21, is placed at exterior of the storing space 13, and the touchpad module 30 is mounted onto this backstop guide trail 21, such that you can drive the backstop guide trail 21 to pull out the touchpad module 30 from the storing space 13 to a backstop position, or recover it within the storing space 13, as shown in FIGS. 3A and 3B. Additionally, a flexible member and a fastener 22 can be embedded into the backstop guide trail 21 in a manner to press and relieve locking and make the touchpad module 30 pop up or press in the touchpad module 30. For the data transmission interface 40, a flexible circuit board 42 is used to connect a connector 41 over the motherboard 11 of case 10 and the touchpad module 30, such that output signal of touchpad module 30 can be sent out, and the touchpad module 30 can be flexibly bent during pulling-out and pressing-in.

In summary, the above is a detailed description of the innovative invention based on a typical preferred embodiment. However, it should be appreciated that the present invention is capable of a variety of embodiments and various modifications by those skilled in the art, and all such variations or changes shall be embraced within the scope of the following claims.

What is claimed is:

1. A recessed touch pad, which is applied to a notebook, generally comprises:
a case having a storing space and a storing port;
a touchpad module used to control the shift of display cursor of a notebook;
an extension and retraction mechanisms placed between said case's storing space and touchpad module, and used to enable the touchpad module to exit/enter said storing space via storing port; and
a data transmission interface placed between said case and said touchpad module, and used to transmit the output signal of said touchpad module.

2. The device as claimed in claim 1, wherein said touchpad module further comprising:
a touch pad used to control the shift of display cursor of a notebook; and
at least one operating key located nearby said touch pad.

3. The device as claimed in claim 1, wherein a notch is placed over said storing port of said case's storing space, and used to expose local area of said touchpad module.

4. The device as claimed in claim 3, wherein said local area indicates said operating key.

5. The device as claimed in claim 1, wherein said extension and retraction mechanism is a backstop guide trail used to pull out said touchpad module or press in storing space.

6. The device as claimed in claim 5, wherein said extension and retraction mechanism's guide trail further comprises a flexible member and a fastener, which are used to press and make said touchpad module pop up.

7. The device as claimed in claim 1, wherein said data transmission interface comprises:
a connector mounted onto the circuit board of said case; and
a flexible circuit board used to connect said connector and touchpad module.
